(19) United States
(12) Patent Application Publication
(10) Pub. No.: US 2002/0135160 A1
(43) Pub. Date: Sep. 26, 2002

(54) Gas bag module

(75) Inventor: Christian Lorenz, Leidersbach (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH & Co. KG

(21) Appl. No.: 10/092,782

(22) Filed: Mar. 7, 2002

(30) Foreign Application Priority Data
Mar. 23, 2001 (DE) 101 14 208.0

(51) Int. Cl. B60R 21/16

(52) U.S. Cl. 280/728.1

(57) ABSTRACT

In a method of joining components of a gas bag module for a vehicle occupant restraint system, at least one component of the gas bag module, preferably the gas bag, is stowed in an envelope. Thereafter, a partial vacuum is produced inside the envelope and the envelope is closed in gas-tight fashion. A gas bag module for a vehicle occupant restraint system consists of at least two components. At least one component is enclosed in gas-tight fashion in an envelope provided with a partial vacuum.

### TECHNICAL FIELD

The invention relates to a method of joining components of a gas bag module. The invention also concerns a gas bag module made of at least two components.

### BACKGROUND OF THE INVENTION

In conventional gas bag modules known from prior art, the finally assembled gas bag module consisting of its individual components is integrated into a space of the vehicle intended for this purpose. In this connection, it is important to make sure that the gas bag module functions also over a period of several years and under the resulting influence of moisture and dust. It is also desired to design the gas bag module with the least possible spatial dimensions.

### BRIEF SUMMARY OF THE INVENTION

The invention provides a gas bag module which functions safely and reliably even under the influence of dust and moisture and which has particularly small spatial dimensions.

According to the invention this is achieved by enclosing at least one component of the gas bag module in gas-tight manner in an envelope provided with a partial vacuum. The gas tight enclosing of at least one component in an envelope prevents this component or these components from being exposed to moisture and dust and thus being impaired as regards its/their function. Since a partial vacuum exists in the interior space of the envelope, the packing dimensions of this component or these components are also reduced in this way. For example, the gas bag may in its folded state be stowed in the envelope provided with a partial vacuum, so that its packing dimensions are reduced to a minimum. Another advantage is that the haptic hardness of the gas bag and thus also the cover disposed over it are increased. The “flabby” feeling resulting when pressure is exerted on the cover of prior art gas bag modules is thus avoided.

The invention also provides a method of joining components of a gas bag module for a vehicle occupant restraint system, which comprises the following steps: At least one component of the gas bag module is stowed in an envelope. The envelope is sealed in gas-tight fashion after producing a partial vacuum in its interior.

As to the advantages of the method according to the invention reference is made to the above described advantages of the gas bag module.

Further features and advantageous embodiments of the invention will be apparent from the subclaims.

### BRIEF DESCRIPTION OF THE DRAWINGS

FIG. 1 shows a schematic view of a gas bag folded in accordance with a first step of a preferred method according to the invention;

FIGS. 2 to 6 show schematic side views of further steps of the preferred method according to the invention;

FIG. 7 shows a schematic side view of a gas bag module joined according to a second preferred method.

### DETAILED DESCRIPTION OF THE PREFERRED EMBODIMENTS

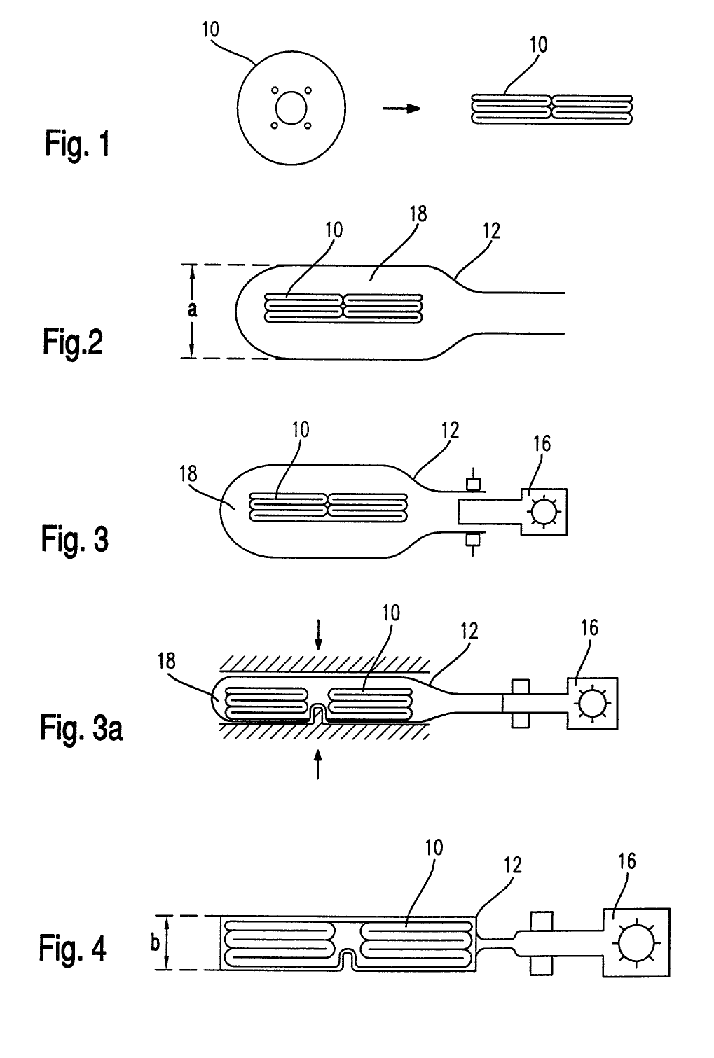

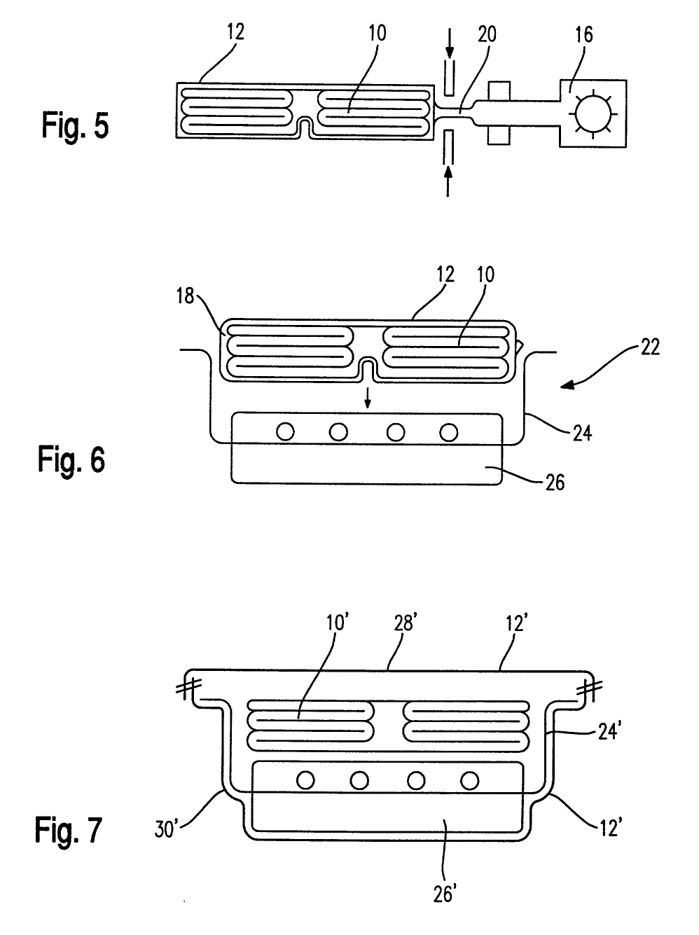

The gas bag 10 shown in FIG. 1 is folded according to one of the folding methods known from the prior art. Thereafter, it is stowed in an envelope 12. The envelope 12 and the gas bag 10 have a packing height a. The envelope may be a thin plastic film, for example. The plastic film 12 advantageously has tear lines (not shown herein) where the plastic film is made thinner so that when the gas bag deploys it can burst along these tear lines. After placing the air bag 10 in the plastic film 12, the shape thereof may be changed subsequently and as required (see FIG. 3a). By the pressure-tight attachment and the actuation of a vacuum pump 16, a partial vacuum is produced inside the interior space 18 (FIGS. 3 and 4), and the original packing height a is lowered to a reduced packing height b. Thereafter, the plastic film 12 is closed in gas-tight fashion e.g. by means of a thermal method and an excess length 20 of the plastic film 12 is removed. The gas bag 10 welded in the plastic film 12 by means of this method is mounted in a gas bag module 22 which has a gas generator 26 already fit into a housing 24. The gas bag module 22 is then integrated into a space of the vehicle intended for this purpose and closed from above with respect to FIG. 6 by means of a cover (not shown).

According to another embodiment of the invention it is provided that in place of the gas bag 10, or optionally also together with the gas bag 10, the gas generator 26 is stowed in the envelope 12.

In the embodiment shown in FIG. 7 the envelope 12′ is made of a cover 28′ and a, with respect to FIG. 7, lower section 30′ of the envelope 12′. In this case, it is optionally possible to shape the cover 28′ during the production process such that it is formed integrally with the, with respect to FIG. 7, lower section 30′ of the envelope 12′. It is, however, also possible that the cover 28′ and the, with respect to FIG. 7, lower section 30′ of the envelope 12′ form two separate components of the gas bag module which during the mounting process are joined with each other in gas-tight fashion e.g. by means of a thermal method. In this embodiment, both the gas generator 26′ as well as the gas bag 10′ and the housing 24′ are stowed in the envelope 12′ in gas-tight manner.

The gas bag module joined in one of the above described ways distinguishes itself in that at least one component is enclosed in gas-tight fashion in the envelope provided with a partial vacuum. Here, it is particularly advantageous for the gas bag to be enclosed in gas-tight fashion in the envelope. It is, however, also provided that in a gas bag module according to the invention the gas bag and/or the gas generator are enclosed in gas-tight fashion in the envelope. According to the invention the pressure slightly increases over a prolonged period of time in such an envelope provided with a partial vacuum and sealed in gas-tight fashion. Yet this is not a drawback, since it is decisive that during the mounting process the small packing dimensions of the enclosed component or components is ensured. In a finally mounted gas bag module the packing dimensions of the components are automatically limited by the dimensions of housing and cover.

1. A method of joining components of a gas bag module for a vehicle occupant restraint system, the method comprising the following steps:
at least one component of said gas bag module is stowed in an envelope;
a partial vacuum is produced in an interior space of said envelope;
said envelope is sealed in gas-tight fashion.

2. The method according to claim 1, wherein subsequently said envelope, which encloses at least one component, and further components of said gas bag module are joined to form said gas bag module.

3. The method according to claim 1, wherein said gas bag module has a gas bag which in a folded state is stowed in said envelope.

4. The method according to claim 3, wherein the shape of said folded gas bag is subsequently changed after having stowing it in said envelope.

5. The method according to claim 3, wherein said envelope has at least one tear line.

6. The method according to claim 1, wherein said gas bag module has a gas generator which is stowed in said envelope.

7. The method according to claim 1, wherein said gas bag module has a cover which forms part of said envelope.

8. A gas bag module for a vehicle occupant restraint system, said gas bag module being comprised of at least two components, at least one of said components being enclosed in gas-tight fashion in an envelope provided with a partial vacuum.

9. The gas bag module according to claim 8, wherein said gas bag is enclosed in gas-tight fashion in said envelope.

10. The gas bag module according to claim 8, wherein a gas generator is provided that is enclosed in gas-tight fashion in said envelope.
